(19) United States
(12) Patent Application Publication
(10) Pub. No.: US 2017/0220040 A1
(43) Pub. Date: Aug. 3, 2017

(54) SMART LUGGAGE SYSTEMS

(71) Applicant: Justin London, Chicago, IL (US)

(72) Inventor: Justin London, Chicago, IL (US)

(21) Appl. No.: 15/417,299

(22) Filed: Jan. 27, 2017

Related U.S. Application Data
(60) Provisional application No. 62/289,924, filed on Feb. 2, 2016.

(51) Int. Cl. G05D 1/00; B60L 1/00; B60Q 5/00; B60R 1/00; B60Q 9/00; B60N 3/06; B60N 3/02; B60K 26/02; A45C 5/14; A45C 5/03; A45C 15/00; A45C 13/24; A45C 9/00; G01S 19/01; G01G 19/00; G05D 1/02

(52) U.S. Cl. CPC G05D 1/0088; G05D 1/0278; B60L 1/006; G05D 1/0022; B60Q 5/00; B60R 1/00; B60Q 9/00; B60N 3/06; B60N 3/02; B60K 26/02; A45C 5/145; A45C 5/03; A45C 15/00; A45C 13/24; A45C 9/00; G01S 19/01; G01G 19/00; B60B 2200/45; B60R 2300/8073; B60K 2026/025; A45C 2009/005

(57) ABSTRACT

Smart luggage systems are disclosed. A smart luggage system includes a luggage bag including one or more wheels, one or more processors, one or more memory modules, one or more wheel actuators, one or more GPS units, and machine readable instructions stored in the one or more memory modules. When executed by the one or more processors, the machine readable instructions cause the smart luggage system to determine a location of a user, determine a location of the luggage bag based on an output signal from the one or more GPS units, and actuate the one or more wheel actuators to move the luggage bag based on the location of the user and the location of the luggage bag.

### CROSS-REFERENCE TO RELATED APPLICATIONS

This application claims the benefit of U.S. Provisional Application No. 62/289,924, entitled “Smart Tracking Luggage Bag,” filed Feb. 2, 2016, the entirety of which is hereby incorporated by reference.

### TECHNICAL FIELD

Embodiments described herein generally relate to smart luggage systems.

### BACKGROUND

People are often required to transport luggage from one place to another. For example, travelers may be required to transport luggage within long corridors of airport terminals. Transporting luggage may be inconvenient, stressful, and require undesirable levels of physical exertion. Even bags that can be rolled on wheels may have to be pulled over long distances, which can strain the arms and back of a person transporting the luggage. Furthermore, conventional luggage typically does not include useful electronic components.

Accordingly, a need exists for smart luggage systems that may mitigate these undesirable features of luggage transportation and/or that include useful electronic components.

### SUMMARY

In one embodiment, a smart luggage system includes a luggage bag. The luggage bag includes one or more wheels. The smart luggage system further includes one or more processors, one or more memory modules communicatively coupled to the one or more processors, one or more wheel actuators coupled to the one or more wheels and communicatively coupled to the one or more processors, one or more GPS units communicatively coupled to the one or more processors, and machine readable instructions stored in the one or more memory modules. When executed by the one or more processors, the machine readable instructions cause the smart luggage system to determine a location of a user, determine a location of the luggage bag based on an output signal from the one or more GPS units, and actuate the one or more wheel actuators to move the luggage bag based on the location of the user and the location of the luggage bag.

In another embodiment, a smart luggage system includes a luggage bag. The luggage bag includes one or more wheels and one or more footrests. The one or more footrests are configured to be deployed from an undeployed stored configuration into a deployed configuration in which a user may stand on the footrests. The smart luggage system further includes one or more processors, one or more memory modules communicatively coupled to the one or more processors, one or more wheel actuators coupled to the one or more wheels and communicatively coupled to the one or more processors, and machine readable instructions stored in the one or more memory modules. When executed by the one or more processors, the machine readable instructions cause the smart luggage system to actuate the one or more wheel actuators to move the luggage with the footrests in the deployed configuration.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates a smart luggage system, according to one or more embodiments shown and described herein;

FIG. 2 illustrates various electronic components of a smart luggage system, according to one or more embodiments shown and described herein; and

FIG. 3 illustrates a smart luggage system including footrests, according to one or more embodiments shown and described herein.

### DETAILED DESCRIPTION

Some embodiments described herein overcome undesirable features of luggage transportation by allowing a user to have her luggage bag track her and move autonomously or semi-autonomously to reduce the exertion and stress associated with lifting and/or pulling luggage bags. The embodiments described herein may still facilitate the lifting or pulling of the luggage bags (e.g., by providing retractable handles and/or straps that may be used to pull and/or lift the luggage bags). However, some embodiments described herein may further allow a user to choose to move along with the user, behind the user, to the side of the user, in front of the user, etc. as the user travels to a destination point without having to do anything other than walk to where the user desired to go. The smart luggage systems described herein further include a number of additional physical and electronic components and provide a number of additional functionalities that are useful to a user of the smart luggage systems.

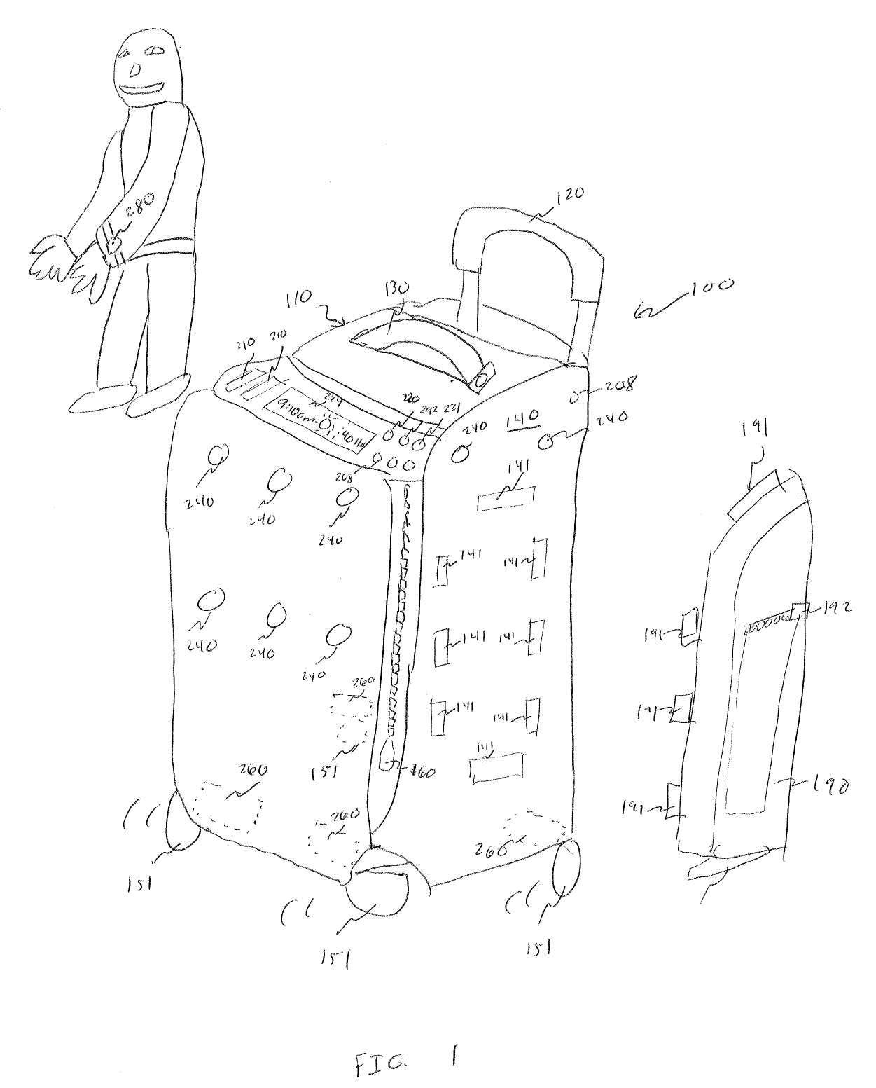

Referring now to FIG. 1, a smart luggage system 100 includes a luggage bag 110 and a compartment addition 190. The luggage bag 110 may be formed from any material. In some embodiments, an exterior of the luggage bag 110 includes a lightweight and durable material, such as nylon and/or polypropylene. In some embodiments, the luggage bag 110 includes a scratch-resistant material. Some embodiments of the luggage bag 110 include foam. The luggage bag 110 may be of any size. In some embodiments, the luggage bag 110 is a carry-on size. In other embodiments, the luggage bag 110 is a checked bag size. The luggage bag 110 includes a retractable handle 120, a strap 130, a side 140, a plurality of compartment addition slots 141, a base 150, a plurality of wheels 151, and a zipper 160.

The retractable handle 120 may be configured to slide upward relative to the base 150 from a stowed configuration to an extended configuration such that the luggage bag 110 may be easily pulled by the retractable handle 120 when the luggage bag 110 is in a transportation mode where the retractable handle 120 is in an extended configuration (e.g., when a traveler pulls the luggage bag 110 by the retractable handle 120). Some embodiments may include an additional retractable handle 120, such as embodiments that include a retractable handle 120 extendible from a top of the luggage bag 110 and from a side of the luggage bag 110.

The strap 130 may be secured to a body of the luggage bag 110 and may be grasped by a traveler in order to carry the luggage bag 110. Some embodiments may include more than one strap. Other embodiments include one or more straps in configurations other than what is shown in FIG. 1. Some embodiments do not include a strap.

The plurality of wheels 151 facilitate rolling of the luggage bag 110 and may be automatically driven by the luggage bag 110 in order to follow a traveler without requiring the traveler to carry or pull the luggage bag 110, as will be described in further detail below. The plurality of wheels 151 may be formed from a durable material, such as rubber. The plurality of wheels 151 may be configured to roll quietly and smoothly. The plurality of wheels 151 may be multidirectional wheels 151 configured to roll in any direction. In some embodiments, the plurality of wheels 151 may rotate in a forward and backward direction and be turned by a steering actuator in order to steer.

The zipper 160 facilitates access to the interior of the luggage bag 110 such that items may be inserted and removed from the luggage bag 110.

The side 140 of the luggage bag 110 includes a plurality of compartment addition slots 141 configured to receive mating protrusions 191 of the compartment addition 190. The compartment addition 190 includes a plurality of protrusions 191 and a zipper 192. The plurality of protrusions 191 of the compartment addition 190 are configured to mate with corresponding slots of the plurality of compartment addition slots 141 when the compartment addition 190 is coupled to the luggage bag 110 to provide additional storage space. Some embodiments may include a different number or configuration of compartment addition slots 141 than what is shown in FIG. 1. Some embodiments may not include compartment addition slots 141. In some embodiments, the compartment addition 190 may be coupled to the luggage bag 110 in a different manner, such as by mating zippers, by fasteners, etc. Such compartment additions allow additional compartments to be seamlessly added and integrated, and/or removed from the luggage bag 110 in order to adjust the storage space of the luggage bag 110 quickly on the fly. Some embodiments may be configured to allow the addition of multiple compartment additions (e.g., embodiments that include multiple sets of compartment addition slots for receiving corresponding protrusions of multiple compartment additions). Such compartment additions may facilitate the addition or subtraction of storage space to the smart luggage system 100 in a convenient “building block” manner. This allows a user to customize the amount of storage space that the luggage system provides and may allow more luggage space to be obtained without requiring the user to utilize multiple luggage bags. In some embodiments, the luggage bag 110 may be a carry-on size and may transform to a checked bag size when one or more compartment additions are added.

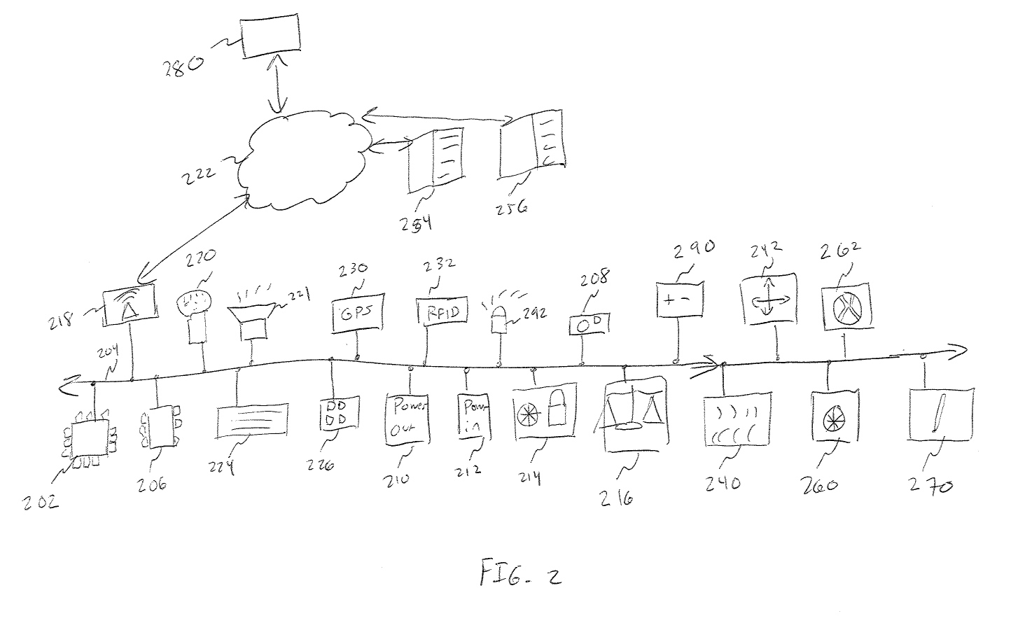

The smart luggage system 100 depicted in FIG. 1 further includes power output ports 210, a display 224, proximity sensors 240, a microphone 220, a speaker 221, an alarm indicator light 292, and a camera 208. The physical location of these components relative to the luggage bag 110 may be different in other embodiments. Some embodiments may include more or less of each type of component depicted in FIG. 1 (e.g., embodiments that include more than one camera 208, etc.). The configuration and functionality of these and additional components of the smart luggage system 100 will be described further with reference to FIG. 2.

Referring now to FIG. 2, additional components of the smart luggage system 100 are schematically depicted. The various components depicted in FIG. 2 may be physically coupled to the luggage bag 110 in any manner and in any location of the luggage bag 110. Some embodiments may include components coupled to the luggage bag 110 in the positions depicted in FIG. 1, though other embodiments may include components coupled in other locations and/or configurations. Some embodiments may not include one or more of the components depicted in FIG. 2, such as embodiments that include only a subset of the components depicted in FIG. 2. Some embodiments may include some components of FIG. 2 that are physically coupled to the luggage bag 110 and other components of FIG. 2 that are not physically coupled to the luggage bag 110 (e.g., when one or more of the components is included in a computing device separate from the luggage bag 110 that communicates with the luggage bag 110).

Still referring to FIG. 2, the smart luggage system 100 includes one or more processors 202, a communication path 204, one or more memory modules 206, one or more cameras 208, one or more power output ports 210, one or more power input ports 212, one or more wheel lock actuators 214, one or more scales 216, network interface hardware 218, one or more microphones 220, one or more speakers 221, one or more displays 224, tactile input hardware 226, one or more GPS units 230, one or more RFID transceivers 232, one or more proximity sensors 240, one or more inertial measurement units 242, one or more wheel actuators 260, one or more steering actuators 262, one or more handle position sensors 270, one or more power supplies 290, and one or more alarm indicator lights 292.

The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the smart luggage system 100. As used herein, the term “communicatively coupled” means that coupled components are capable of exchanging data signals with one another such as, for example, electrical signals via conductive medium, electromagnetic signals via air, optical signals via optical waveguides, and the like.

Each of the one or more processors 202 may be any device capable of executing machine readable instructions. Accordingly, each of the one or more processors 202 may be a controller, an integrated circuit, a microchip, a computer, or any other computing device. The one or more processors 202 are communicatively coupled to the other components of the smart luggage system 100 by the communication path 204. Accordingly, the communication path 204 may communicatively couple any number of processors with one another, and allow the modules coupled to the communication path 204 to operate in a distributed computing environment. Specifically, each of the modules may operate as a node that may send and/or receive data.

Each of the one or more memory modules 206 is coupled to the communication path 204 and communicatively coupled to the one or more processors 202. The one or more memory modules 206 may comprise RAM, ROM, flash memories, hard drives, or any device capable of storing machine readable instructions such that the machine readable instructions can be accessed and executed by the one or more processors 202. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 206. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more memory modules 206, the one or more processors 202, and/or any of the other components of the smart luggage system 100 may be coupled to a printed circuit board or other substrate. In some embodiments, one or more printed circuit boards including various components of the smart luggage system 100 may be disposed in a base of the smart luggage system 100, though embodiments are not limited thereto.

The one or more memory modules 206 include machine readable instructions that, when executed by the one or more processors 202, cause the smart luggage system 100 to perform the actions described below. For example, the one or more memory modules 206 may include machine readable instructions that, when executed by the one or more processors 202, cause the smart luggage system 100 to track a user, as described herein.

The one or more memory modules 206 may include machine readable instructions that, when executed by the one or more processors 202, cause the smart luggage system 100 to recognize speech received by the one or more microphones 220 (e.g., voice commands and phrases such as “Come here,” “Go faster,” “stop,” “get weather information,” “get flight information,” etc.) and control the smart luggage system 100 and/or cause the smart luggage system 100 to provide an output in response to the recognized speech input. The one or more memory modules 206 may include one or more speech recognition algorithms, such as an automatic speech recognition engine that processes speech input signals received from the one or more microphones 220 and/or extracts speech information from such signals. Furthermore, the one or more memory modules 206 may include machine readable instructions that, when executed by the one or more processors 202, cause the speech recognition to perform the actions such as but not limited to causing the luggage bag 110 to move, causing the luggage bag 110 to track a user, adjusting one or more settings of the smart luggage system 100, etc. In some embodiments, the speech recognition algorithm may be programmed or customized to only recognize and be controlled with the user's voice, so that only known users can control the smart luggage system 100 and change settings and therefore provide further theft deterrence.

The one or more cameras 208 is coupled to the communication path 204 and communicatively coupled to the one or more processors 202. Each of the one or more cameras 208 may be any device having an array of sensing devices (e.g., pixels) capable of detecting radiation in an ultraviolet wavelength band, a visible light wavelength band, or an infrared wavelength band. Each of the one or more cameras 208 may have any resolution. The one or more cameras 208 may include an omni-directional camera, or a panoramic camera. In some embodiments, one or more optical components, such as a mirror, fish-eye lens, or any other type of lens may be optically coupled to the one or more cameras 208.

The one or more power output ports 210 are configured to output power from the one or more power supplies 290 of the smart luggage system 100 to an external device, such as to charge or power the external device. For example, external devices, such as smartphones, tablets, or the like may be charged when electrically coupled to the one or more power output ports 210. In some embodiments, the one or more power output ports 210 include a USB port, a DC jack, or the like. In some embodiments, the one or more power output ports 210 is coupled to the communication path 204 and communicatively coupled to the one or more processors 202 such that the one or more processors 202 execute machine readable instructions stored in the one or more memory modules 206 in order to control the power output from the one or more power output ports 210.

The one or more power input ports 212 are configured to receive power from an external power supply (e.g., the electrical grid, an external battery, an external electrical device, etc.) to power the smart luggage system 100 and/or to charge the one or more power supplies 290 of the smart luggage system 100. In some embodiments, the one or more power input ports 212 is coupled to the communication path 204 and communicatively coupled to the one or more processors 202 such that the one or more processors 202 execute machine readable instructions stored in the one or more memory modules 206 in order to control the power input at the one or more power input ports 212.

Some embodiments do not include separate power input ports and power output ports, such as embodiments that include one or more power ports configured to both output power (e.g., to recharge or power external devices) and receive power (e.g., to recharge the one or more power supplies 290). Some embodiments may include redundant power supplies (e.g., multiple power supplies). Some embodiments may include an integrated battery charger for recharging electronic devices and other battery power supplies.

The one or more wheel lock actuators 214 is communicatively coupled to the communication path 204 and communicatively coupled to the one or more processors 202 such that the one or more processors 202 execute machine readable instructions stored in the one or more memory modules 206 in order to control the actuation of the one or more wheel lock actuators 214. When actuated, the one or more wheel lock actuators 214 lock one or more of the plurality of wheels 151 in a locked configuration in which the locked plurality of wheels 151 are prevented from rotating. In some embodiments, the wheel lock actuators 214 may be configured to comply with one or more sets of regulations, such as TSA regulations.

The one or more scales 216 is communicatively coupled to the communication path 204 and communicatively coupled to the one or more processors 202 such that the one or more processors 202 execute machine readable instructions stored in the one or more memory modules 206 in order to control the one or more scales 216 and to receive a weight signal from the one or more scales 216 indicative of a weight of contents of the luggage bag 110. In some embodiments, the one or more scales 216 include at least one digital scale. In some embodiments, the one or more scales 216 is integrated in the luggage bag 110, such as when the one or more scales 216 is disposed in a base of the luggage bag 110. When the one or more scales 216 is integrated in a base of the luggage bag 110, the one or more scales 216 may output a signal proportional of a weight of the contents of the luggage bag 110 when the luggage bag 110 is upright such that the weight of the contents of the luggage bag is received by the scale. Then smart luggage system 100 may then determine a weight of the bag based on the received signal, such as by determining a weight of the contents based on the signal and adding a known weight of the bag to obtain a total weight of the bag and its contents. In some embodiments, the total weight may be displayed on the one or more displays 224 to allow a user to determine if the bag complies with airline weight restrictions.

The one or more displays 224 provide visual output. The one or more displays 224 are coupled to the communication path 204 and communicatively coupled to the one or more processors 202. Accordingly, the communication path 204 communicatively couples the one or more displays 224 to other modules of the smart luggage system 100. Each of the one or more displays 224 may include any medium capable of transmitting an optical output such as, for example, a cathode ray tube, light emitting diodes, a liquid crystal display, a plasma display, or the like. Moreover, the one or more displays 224 may include a touch screen that, in addition to providing optical information, detects the presence and location of a tactile input upon a surface of or adjacent to the one or more displays 224. Accordingly, the one or more displays 224 may receive mechanical input directly upon the optical output provided by the one or more displays 224. For example, in some embodiments, the one or more displays 224 may display one or more prompts and receive mechanical input used to set one or more parameters of the smart luggage system 100, such as a mode of operation (e.g., an autonomous mode, a remote control mode, a tracking mode, etc.), geofence parameters such as a geofence perimeter, speed parameters, power options, etc. and/or to request information, such as weather information, hotel information, travel information, remaining battery power, stock quotes, etc. In some embodiments, the one or more displays 224 display information received from an external source (e.g., from information received at the network interface hardware 218 from one or more computing devices communicatively coupled to the smart luggage system 100 by the network 222), such as weather information and/or sports information. In some embodiments, such information is displayed in response to a voice command requesting the display of such information, which causes the smart luggage system 100 to send a message requesting the information via the network interface hardware 218, receive the information at the network interface hardware 218 in response to the request, and display the received information.

The one or more speakers 221 transforms data signals into mechanical vibrations, in order to output audible prompts or audible information from the smart luggage system 100. The one or more speakers 221 is coupled to the communication path 204 and communicatively coupled to the one or more processors 202. In some embodiments, one or more of the one or more speakers 221 is waterproof. In some embodiments, the one or more speakers 221 is configured to output a high decibel audio alarm, such as when an alarm event is detected and/or the smart luggage system 100 determines that it is being tampered with or is being attempted to be stolen.

The one or more alarm indicator lights 292 transform data signals into an illuminated signal in order to output visual alarm indications. In some embodiments, the one or more alarm indicator lights 292 include one or more light emitting diodes. The one or more alarm indicator lights 292 may allow a user to know when an alarm is set. For example, when a user indicates that the alarm is on, the one or more alarm indicator lights 292 may blink. Similarly, the one or more alarm indicator lights may blink or remain lit when the smart luggage system 100 senses an alarm event that causes the alarm to be activated.

The tactile input hardware 226 is coupled to the communication path 204 such that the communication path 204 communicatively couples the tactile input hardware 226 to other modules of the smart luggage system 100. The tactile input hardware 226 may be any device capable of transforming mechanical, optical, or electrical signals into a data signal capable of being transmitted with the communication path 204. Specifically, the tactile input hardware 226 may include any number of movable objects that each transform physical motion into a data signal that can be transmitted to over the communication path 204 such as, for example, a button, a switch, a knob, a microphone or the like.

The microphone 220 transforms acoustic vibrations received by the microphone 220 into a speech input signal. The microphone 220 is coupled to the communication path 204 and communicatively coupled to the one or more processors 202. The one or more processors 202 may process the speech input signals received from the microphone 220 and/or extract speech information from such signals to generate a response.

The network interface hardware 218 communicatively couples the smart luggage system 100 with a computing device 280 (e.g., a key fob, a handheld computing device, a smartwatch, a device configured to be coupled to a belt, a smartphone, one or more of the components described in U.S. patent application Ser. No. 14/950,556, filed on Nov. 24, 2015 and entitled “Multi-Modal Tracking Locator Alarm System,” the contents of which are hereby incorporated by reference, etc.) via a computer network 222. The network interface hardware 218 is coupled to the communication path 204 such that the communication path 204 communicatively couples the network interface hardware 218 to other modules of the smart luggage system 100. The network interface hardware 218 can be any device capable of transmitting and/or receiving data via a wireless or cellular network. Accordingly, the network interface hardware 218 can include a communication transceiver for sending and/or receiving data according to any wireless communication standard. For example, the network interface hardware 218 may include a chipset (e.g., antenna, processors, machine readable instructions, etc.) to communicate over wireless computer networks such as, for example, wireless fidelity (WiFi), WiMax, Bluetooth, IrDA, Wireless USB, Z-Wave, ZigBee, or the like. In some embodiments, the network interface hardware 218 includes a Bluetooth transceiver that enables the smart luggage system 100 to exchange information with the computing device 280 via Bluetooth communication. The network interface hardware 218 may be embedded in the luggage bag 110, placed at or near the top of the luggage bag 110 (e.g., near the one or more displays 224), or in any other location.

Data from the computing device 280 may be provided to the smart luggage system 100 via the network interface hardware 218. Specifically, the smart luggage system 100 may include an antenna for communicating over one or more of the wireless computer networks described above. Moreover, the smart luggage system 100 may include a mobile antenna for communicating with the network 222. Accordingly, the antenna may be configured to send and receive data according to a mobile telecommunication standard of any generation (e.g., 1G, 2G, 3G, 4G, 5G, etc.).

The network 222 generally includes one or more computing devices configured to receive and transmit data according to a network communication protocol. In some embodiments, the network 222 includes a wired systems such as public switched telephone network (PSTN) or a backhaul networks. In some embodiments, the network 222 includes one or more of a wide area network, a metropolitan area network, the Internet, a satellite network, or the like. Further example networks include but are not limited to GSM, GPRS, and WCDMA. Thus, the network 222 generally include one or more antennas, transceivers, and processors that execute machine readable instructions to exchange data over various wired and/or wireless networks.

In some embodiments, the network 222 can be utilized as a wireless access point by the smart luggage system 100 to access one or more servers (e.g., a first server 254 and/or a second server 256). The first server 254 and second server 256 generally include processors, memory, and chipset for delivering resources via the network 222. Resources can include providing, for example, processing, storage, software, and information from the first server 254 and/or the second server 256 to the smart luggage system 100 via the network 222. Additionally, it is noted that the first server 254 or the second server 256 can share resources with one another over the network 222 such as, for example, via the wired portion of the network, the wireless portion of the network, or combinations thereof.

The one or more servers accessible by the smart luggage system 100 via the network 222 may include third party servers that provide additional capability for performing the functionality described herein. The smart luggage system 100 and/or the computing device 280 may be communicatively coupled to any number of servers by way of the network 222.

The one or more GPS units 230 are coupled to the communication path 204 such that the communication path 204 communicatively couples the one or more GPS units 230 to other modules of the smart luggage system 100. The one or more GPS units 230 is configured to receive signals from GPS satellites. Specifically, in one embodiment, the one or more GPS units 230 includes one or more satellite antennas including conductive elements that interact with electromagnetic signals transmitted by GPS satellites. The received signal is transformed into a data signal indicative of the location (e.g., latitude and longitude) of the smart luggage system 100, by the one or more processors 202. Additionally, it is noted that the one or more GPS units 230 may include at least one of the one or more processors 202 and the one or memory modules 206. The data may then be stored on one of one or more memory modules 206 of the smart luggage system 100 or the memory of a network server as described above.

The one or more RFID transceivers 232 are coupled to the communication path 204 such that the communication path 204 communicatively couples the one or more GPS units 230 to other modules of the smart luggage system 100. The one or more RFID transceivers 232 includes one or more RFID antennas and communication hardware capable of sending and/or receiving RFID signals.

The one or more proximity sensors 240 is coupled to the communication path 204 such that the communication path 204 communicatively couples the one or more proximity sensors 240 to other modules of the smart luggage system 100. The one or more proximity sensors 240 may include any device capable of outputting a proximity signal indicative of a proximity of the smart luggage system 100 to another object. In some embodiments, the one or more proximity sensors 240 may include a laser scanner, a capacitive displacement sensor, a Doppler effect sensor, an eddy-current sensor, an ultrasonic sensor, a magnetic sensor, an optical sensor, a radar sensor, a LIDAR sensor, a sonar sensor, or the like. Some embodiments may not include the one or more proximity sensors 240, such as embodiments in which the proximity of the smart luggage system 100 to an object is determine from inputs provided by other sensors (e.g., the one or more cameras 208, the one or more speakers 221, etc.) or embodiments that do not determine a proximity of the smart luggage system 100 to an object. The output signal or signals from the one or more proximity sensors 240 may be processed by the one or more processors 202, when executing machine readable instructions stored in the one or more memory modules 206, in order to track another object (e.g., a user of the smart luggage system 100), detect motion of another object (e.g., a user to be tracked or an obstacle to be avoided), detect the distance to another object (e.g., a distance to a user to be tracked or to an obstacle to be avoided) and control the smart luggage system 100 in response to such object tracking, motion detection, and/or distance detection, such as by controlling the one or more wheel actuators 260 and/or the one or more steering actuators 262. In some embodiments, the one or more proximity sensors 240 include a plurality of proximity sensors including at least one proximity sensor on a front of the luggage bag 110, at least one proximity sensor on each side of the luggage bag 110, and at least one proximity sensors on a rear of the luggage bag 110.

The one or more inertial measurement units 242 is coupled to the communication path 204 such that the communication path 204 communicatively couples the one or more inertial measurement units 242 to other modules of the smart luggage system 100. The one or more inertial measurement units 242 may include one or more accelerometers and one or more gyroscopes. The one or more inertial measurement units 242 transforms sensed physical movement of the smart luggage system 100 into a signal indicative of an orientation, a rotation, a velocity, or an acceleration of the smart luggage system 100. The operation of the smart luggage system 100 may depend on an orientation of the smart luggage system 100 (e.g., whether the smart luggage system 100 is unstable, tilted, and the like), such as embodiments in which the one or more wheel actuators 260 and/or the one or more steering actuators 262 are controlled to stabilize the bag in response to detected instability, tilting, or the like. Some embodiments of the smart luggage system 100 may not include the one or more inertial measurement units 242, such as embodiments that include an accelerometer but not a gyroscope, embodiments that include a gyroscope but not an accelerometer, or embodiments that include neither an accelerometer nor a gyroscope.

The one or more wheel actuators 260 is coupled to the communication path 204 such that the communication path 204 communicatively couples the one or more wheel actuators 260 to other modules of the smart luggage system 100. The one or more wheel actuators 260 are controlled by machine readable instructions stored in the one or more memory modules 206 that, when executed by the one or more processors 202, drive the one or more wheel actuators 260 to rotate the plurality of wheels 151 and move the smart luggage system 100. In some embodiments, the one or more wheel actuators 260 includes one or more drive motors (e.g., DC drive motors) coupled to the plurality of wheels 151. In some embodiments, a separate wheel actuator is associated with each driven wheel of the plurality of wheels 151 such that a separate actuator is coupled to each of a plurality of front drive wheels and each of a plurality of rear drive wheels. In some embodiments, a single wheel actuator is coupled to multiple driven wheels of the plurality of wheels 151 (e.g., by an axle, a differential mechanism, etc.).

The one or more steering actuators 262 is coupled to the communication path 204 such that the communication path 204 communicatively couples the one or more steering actuators 262 to other modules of the smart luggage system 100. The one or more steering actuators 262 are controlled by machine readable instructions stored in the one or more memory modules 206 that, when executed by the one or more processors 202, steer the smart luggage system 100 as the smart luggage system 100 moves.

The one or more wheel actuators 260 and/or the one or more steering actuators 264 facilitate 360 degree movement of the bag in all directions in some embodiments. Some embodiments may not include the one or more steering actuators, such as embodiments in which the one or more wheel actuators 260 also accomplish steering of the smart luggage system 100. Some embodiments may include at least one of the one or more wheel actuators 260 and/or the one or more steering actuators 264 in a separate compartment that can be seamlessly and securely inserted into and removed from the smart luggage system 100, thereby potentially reducing the weight or size of the luggage bag 110 when the user wants to use the luggage bag 110 as a carry-on bag and/or for short trips. Thus, in such embodiments the user could take both the separate actuator compartment(s) and the rest of the luggage bag 110 (which may include other attachable compartments that can be added to the outside of the luggage bag 110 in some embodiments) as separate carry-on items (e.g., to meet carry-on bag size requirement restrictions) that can be reattached at a later time (e.g., when the user reaches a destination).

The one or more handle position sensors 270 is coupled to the communication path 204 such that the communication path 204 communicatively couples the one or more handle position sensors 270 to other modules of the smart luggage system 100. Some embodiments may receive input from the retractable handle 120, such as embodiments in which the smart luggage system 100 includes footrests that a user can stand on and control the movement of the smart luggage system 100 with the retractable handle 120. In some such embodiments, the one or more handle position sensors 270 outputs a signal indicative of a position of the retractable handle 120, which is used to control the one or more wheel actuators 260 and/or the one or more steering actuators 262 in order to control movement of the smart luggage system 100.

At least some of the functionality of the smart luggage system 100 may be embedded in a mobile device, such as a smartphone, and the user may then access communications from the luggage bag 110, and transmits communications to the luggage bag 110 through an application interface that operates over the network 222. As such, the smart luggage system 100 as described herein may also include a mobile device such as a smart phone, a laptop computer, tablet, etc.

The one or more power supplies 290 may include one or more batteries. In some embodiments that include one or more batteries in the one or more power supplies 290, the one or more batteries may include a rechargeable lithium ion battery that supplies power to the different components of the smart luggage system 100. In some embodiments, the one or more power supplies includes embedded chips. The embedded chips may include a Radio Frequency Identification (RFID) chip, a Global Position System (GPS) chip, a Bluetooth® chip, WiFi chip, or a combination thereof, supporting wireless and GSM network data communications such as general packet radio system (GPRS). GPRS supports SMS messaging and broadcasting, push to talk over cellular (PoC), and instant message and presence. Some embodiments may include one or more solar cells in the one or more power supplies 290. In some embodiments, the one or more power supplies 290 include at least one back-up power supply. Some embodiments may derive power at least in part from energy harvested from the environment. Some embodiments may include other devices configured to transform one type of energy into electrical energy for powering the various components of the smart luggage system 100.

In some embodiments, the smart luggage system 100 does not include all of the components depicted in FIG. 2. Furthermore, in some embodiments, the smart luggage system 100 includes additional components other than those depicted in FIG. 2.

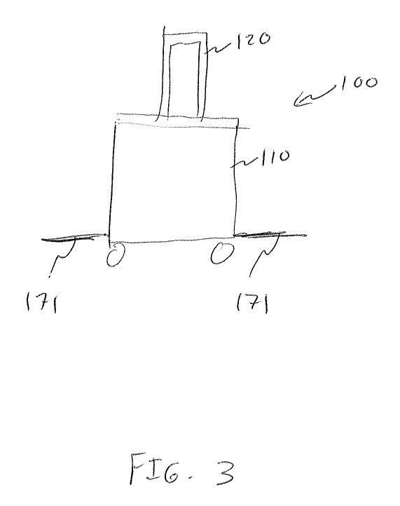

Referring now to FIG. 3, an embodiment of a smart luggage system 100 including footrests is schematically depicted. The smart luggage system 100 includes a plurality of footrests 171, which a traveler may stand on and be moved along with the smart luggage system 100. The footrests may be stored in the luggage bag 110 (e.g., in a base of the luggage bag 110) and configured to extend outward from the luggage bag 110 in a deployed configuration (e.g., by popping out of the base). Other embodiments may include footrests that fold up to engage a side of the luggage bag 110 in an undeployed configuration and unfold to be perpendicular to the side of the luggage bag 110 in a deployed configuration. The traveler may control movement of the smart luggage system 100 by moving the retractable handle 120 (e.g., forward and backward to move forward and backward, and left and right to turn left and right, respectively). In some embodiments, the smart luggage system 100 may include additional control components, such as embodiments in which the tactile input hardware 266 includes a brake actuator, a throttle actuator, speed control buttons, directional control buttons, and the like. Some embodiments may include handlebars, which may stored in the luggage bag 110 in a stored configuration and automatically raised and deployed in a deployed configuration such that a user may stand on the plurality of footrests 171 and hold onto the handlebars to be transported by the luggage bag 110. In some embodiments, at least one handlebar includes tactile input hardware (e.g. separate switches for braking and acceleration) that the user may manipulate while standing on the footrests in order to brake and accelerate the smart luggage system.

Various functionality and features of the smart luggage system 100 will now be described with reference to FIGS. 1-3.

User Tracking/Following

In some embodiments, the smart luggage system 100 may be configured to move along with a user in an autonomous or semi-autonomous mode that does not require the user to pull or carry the luggage bag 110.

In some such embodiments, a user may wear or carry the computing device 280 (e.g., a wireless fob, a transmitter watch, a smartphone, a smartwatch, a device configured to be work on a belt, etc.) that the luggage bag 110 tracks, such that the luggage bag functions as an autonomous or semi-autonomous robot that follows or tracks a location of the user as the user moves. In some embodiments, the smart luggage system 100 may receive a wireless signal from the computing device 280 worn or carried by the user, determine a strength of the wireless signal, determine a location of the user based on the strength of the wireless signal, and adjust movement of the luggage bag 110 (e.g. by controlling the one or more wheel actuators 260 and/or the one or more steering actuators 262) to maintain the strength of the wireless signal within a threshold. In some embodiments, the smart luggage system 100 may receive a message at the network interface hardware 218 containing a GPS location of the user (e.g., a message transmitted from the computing device 280 that includes the GPS location of the computing device 280), determine a location of the luggage bag 110 based on a signal output by the one or more GPS units 230, and control the movement of the luggage bag 110 (e.g. by controlling the one or more wheel actuators 260 and/or the one or more steering actuators 262) based on the received location of the computing device 280 and the determined location of the luggage bag 110. For example, the one or more wheel actuators 260 and/or the one or more steering actuators 262 may be controlled to maintain a predetermined distance between the location of the computing device 280 and the determined location of the luggage bag 110, to match a speed of the computing device 280 of the user, or the like. In some embodiments that match a speed of a user (e.g., based on a speed of a user determined from messages received from a computing device 280 coupled to or carried by the user, based on one or more output signals from the one or more proximity sensors 240, based on the signal received from the computing device 280, etc.), the smart luggage system 100 determines that a user has slowed down to a slower speed and slows down the luggage bag 110 (e.g. by controlling the one or more wheel actuators 260 and/or the one or more steering actuators 262) to match the slower speed. In some embodiments that match a speed of a user (e.g., based on a speed of a user determined from messages received from a computing device 280 coupled to or carried by the user, based on one or more output signals from the one or more proximity sensors 240, based on the signal received from the computing device 280, etc.), the smart luggage system 100 determines that a user has sped up to a faster speed and speeds up the luggage bag 110 (e.g. by controlling the one or more wheel actuators 260 and/or the one or more steering actuators 262) to match the faster speed. In some embodiments that utilize the computing device 280 to accomplish tracking, a user may provide the computing device 280 to another user, such that the luggage bag 110 tracks the other user, such that the other user may watch the luggage bag 110 while the owner uses the restroom, etc.

In some embodiments, the smart luggage system 100 recognizes a user based on image data received from the one or more cameras 208, continues to receive image data of the recognized user, determines a location of the user based on the image data, and moves the luggage bag 110 to track the user (e.g. by controlling the one or more wheel actuators 260 and/or the one or more steering actuators 262) based on the location of the user and the location of the luggage bag. In some embodiments, the luggage bag 110 adjusts its movement based on sensed inclines or ramps (e.g., sensed based on one or more signals output by the one or more inertial measurement units 242). Based on the one or more signals output by the one or more inertial measurement units 242, the smart luggage system 100 can calculate one or more signals and/or control the one or more wheel actuators 260 and/or the one or more steering actuators 262 as appropriately to move up an angle of ascent and/or down an angle of descent to avoid tipping over or to track the user. In addition, the one or more signals output by the one or more inertial measurement units 242 may be used to control the one or more wheel actuators 260 and/or the one or more steering actuators 262 in order to change the tilt of the luggage bag 110 as it travels up or down an incline, thereby adjusting its weight to maintain speed and stability.

In some embodiments, the smart luggage system 100 causes the luggage bag 110 to track or follow a user based on one or more output signals from the one or more proximity sensors 240. For example, the one or more output signals of the one or more proximity sensors 240 may be used to determine a location of a user and/or a distance of the user from the luggage bag 110. The luggage bag 110 may be controlled to move (e.g. by controlling the one or more wheel actuators 260 and/or the one or more steering actuators 262) such that a threshold distance, as determined based on the one or more output signals of the one or more proximity sensors 240, between a location of the luggage bag and a location of the user is maintained.

In some embodiments, the smart luggage system 100 includes multiple tracking modes, such as a side tracking mode, a rear tracking mode, and a forward tracking mode. In the forward tracking mode, the luggage bag 110 is configured to move in front of the user as the luggage bag 110 tracks the user. In the rear tracking mode, the luggage bag 110 is configured to move behind the user as the luggage bag 110 tracks the user. In the side tracking mode, the luggage bag 110 is configured to move beside the user as the luggage bag tracks the user. The user may select the tracking mode by providing input to the smart luggage system 100 (e.g., by providing input to the one or more microphones 220, the tactile input hardware 226, and/or the one or more displays 224).

As the bag moves to track the user, the one or more wheel actuators 260 and/or the one or more steering actuators 262 may be controlled to cause the bag to avoid obstacles (e.g., obstacles detected by the one or more cameras 208 and/or the one or more proximity sensors 240).

In some embodiments, the luggage bag 110 may be tracked by one or more of the control devices, transmitters, or receivers described in U.S. patent application Ser. No. 14/950,556, filed on Nov. 24, 2015 and entitled “Multi-Modal Tracking Locator Alarm System,” the contents of which are hereby incorporated by reference.

Geofence Perimeter Violation Alarm

In some embodiments, the smart luggage system 100 includes a geofence perimeter around a user. The geofence perimeter may be predetermined or customized (e.g. by providing input via the one or more displays 224 and/or the tactile input hardware 226). In some embodiments, the geofence perimeter may be a threshold distance between a determined location of the user (which may be determined based on a location of the computing device 280, one or more output signals from the one or more proximity sensors 240, etc.) and the location of the luggage bag 110 (which may be determined based on one or more output signals of the one or more GPS units 230, etc.). When the smart luggage system 100 determines that the luggage bag 110 is located outside of the geofence perimeter, the luggage system may issue an alarm, for example by outputting a high decibel alarm with the one or more speakers 221, activating the one or more alarm indicator lights 292, or the like. Some embodiments may activate the one or more wheel lock actuators 214 in response to determining that the luggage bag 110 is located outside the geofence perimeter. Such an alert may provide a notification that the bag is being stolen or that the bag is no longer properly following the user (e.g. because the bag fell over, is disabled, is off track, etc.).

Tampering Alarm

In some embodiments, the smart luggage system 100 provides a tampering notification when the smart luggage system 100 determines that the bag is being tampered with (e.g., when a user other than the owner of the bag attempts to touch the bag or move the bag). In some embodiments, the smart luggage system 100 determines that the bag is being tampered with based on image data from the one or more cameras 208 and/or one or more output signals from the one or more inertial measurement units 242. Some embodiments may transmit the location of the luggage bag 110 (e.g. determined based on an output signal from the one or more GPS units 230) with the network interface hardware 218 in response to determining that the bag is being tampered with. When the smart luggage system 100 determines that the luggage bag 110 is being tampered with, the luggage system may issue an alarm, for example by outputting a high decibel alarm with the one or more speakers 221, activating the one or more alarm indicator lights 292, or the like. Some embodiments may capture and/or transmit image data from the one or more cameras 208 in response to determining that the bag is being tampered with, such as to capture vide of would-be thieves tampering with the smart luggage system 100. Some embodiments may activate the one or more wheel lock actuators 214 in response to determining that the luggage bag 110 is being tampered with. In other embodiments, the smart luggage system 100 determines that the bag is being tampered with based on detecting signal strength variations in the communication between the computing device 280 worn by or held by the user and the luggage bag 110. For example, the smart luggage system 100 may detect that the signal strength has decreased by a threshold amount (e.g. due to interference of another person between the user and the luggage bag 110), and determine that tampering has occurred or is likely in response to detecting that the signal strength has decreased by the threshold amount.

Grounded Mode

A traveler may set the luggage bag 110 into grounded mode (e.g. by providing input indicative of a desire to set the grounded mode via the one or more displays 224 and/or the tactile input hardware 226). In response to receiving the request to enter grounded mode, the one or more wheel lock actuators 214 may lock the plurality of wheels 151 such that the plurality of wheels 151 will not rotate. In grounded mode, alarm monitoring may be commenced such that the smart luggage system 100 is configured to activate an alarm (e.g., by outputting a high-decibel alarm notification with the one or more speakers 221 and/or by activating the one or more alarm indicator lights 292) when the bag is attempted to be moved (e.g., as determined based on input from the one or more cameras 208, input from the one or more proximity sensors 240 and/or input from the one or more inertial measurement units 242). In some embodiments, the grounded mode may be deactivated when a user enters a password (e.g., by providing input to the tactile input hardware 226, providing input to the one or more microphones 220, providing input to the one or more displays 224, etc.) or otherwise authenticates (e.g., with voice input received at the one or more microphones 220, facial recognition with the one or more cameras 208, etc.) with the smart luggage system 100. When the grounded mode is deactivated, alarm monitoring is ceased and the one or more wheel lock actuators 214 are deactivated in some embodiments. Such a grounded mode allows a user who travels alone to keep her bag secured even if she has to step away from the bag. In some embodiments, only an authorized user can deactivate an alarm, such as through a fob, a smartphone, or password/security code entered by tactile input on the one or more displays 224. In some embodiments, the luggage bag 110 may generate a signal to alert the user (e.g., by transmitting a message with the network interface hardware 218, such as a message that causes an SMS text message to be sent to a smartphone of the user) that the alarm has been activated and/or the bag has been moved. In some embodiments, the alarm will continue to sound (e.g., will be continue to be output by the one or more speakers 221) until the user deactivates the alarm. Some embodiments include a computerized voice alert output through one or more high decibel audio speakers (e.g., the one or more speakers 221) that alerts the public that the bag is stolen.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A smart luggage system comprising:
a luggage bag comprising one or more wheels;
one or more processors;
one or more memory modules communicatively coupled to the one or more processors;
one or more wheel actuators coupled to the one or more wheels and communicatively coupled to the one or more processors;
one or more GPS units communicatively coupled to the one or more processors; and
machine readable instructions stored in the one or more memory modules that cause the smart luggage system to perform at least the following when executed by the one or more processors:
determine a location of a user;
determine a location of the luggage bag based on an output signal from the one or more GPS units; and
actuate the one or more wheel actuators to move the luggage bag based on the location of the user and the location of the luggage bag.

2. The smart luggage system of claim 1, further comprising:
a scale communicatively coupled to the one or more processors; and
one or more displays communicatively coupled to the one or more processors,
wherein, when executed by the one or more processors, the machine readable instructions stored in the one or more memory modules cause the smart luggage system to:
determine a weight of the luggage bag and its contents based on an output signal from the scale; and
display the weight on the one or more displays.

3. The smart luggage system of claim 1, further comprising one or more power supplies and one or more power output ports electrically coupled to the one or more power supplies and configured to output power to an external device when the external device is electrically connected to the one or more power output ports.

4. The smart luggage system of claim 1, further comprising network interface hardware communicatively coupled to the one or more processors, wherein, when executed by the one or more processors, the machine readable instructions stored in the one or more memory modules cause the smart luggage system to receive a wireless signal with the network interface hardware, determine a strength of the wireless signal, and determine the location of the user based on the strength of the wireless signal.

5. The smart luggage system of claim 1, further comprising network interface hardware communicatively coupled to the one or more processors, wherein, when executed by the one or more processors, the machine readable instructions stored in the one or more memory modules cause the smart luggage system to receive a message with the network interface hardware and determine a location of the user based on the message.

6. The smart luggage system of claim 1, further comprising one or more cameras communicatively coupled to the one or more processors, wherein, when executed by the one or more processors, the machine readable instructions stored in the one or more memory modules cause the smart luggage system to receive image data from the one or more cameras and determine the location of the user based on the image data.

7. The smart luggage system of claim 1, further comprising one or more proximity sensors communicatively coupled to the one or more processors, wherein, when executed by the one or more processors, the machine readable instructions stored in the one or more memory modules cause the smart luggage system to receive one or more output signals from the one or more proximity sensors and determine the location of the user based on the one or more output signals from the one or more proximity sensors.

8. The smart luggage system of claim 1, wherein, when executed by the one or more processors, the machine readable instructions stored in the one or more memory modules cause the smart luggage system to determine a speed of the user and actuate the one or more wheel actuators to move the luggage bag to match the speed of the user.

9. The smart luggage system of claim 1, further comprising:
at least one of one or more speakers and one or more alarm indicator lights; and
a geofence perimeter stored in the one or more memory modules,
wherein, when executed by the one or more processors, the machine readable instructions stored in the one or more memory modules cause the smart luggage system to:
determine that the location of the luggage bag is outside the geofence perimeter; and
issue an alarm with the at least one of one or more speakers and one or more alarm indicator lights.

10. The smart luggage system of claim 1, further comprising one or more wheel lock actuators coupled to the one or more wheels and communicatively coupled to the one or more processors, wherein, when executed by the one or more processors, the machine readable instructions stored in the one or more memory modules cause the smart luggage system to actuate the one or more wheel lock actuators to prevent the one or more wheels from rotating.

11. The smart luggage system of claim 1, further comprising:
one or more inertial measurement units communicatively coupled to the one or more processors; and
at least one of one or more speakers and one or more alarm indicator lights,
wherein, when executed by the one or more processors, the machine readable instructions stored in the one or more memory modules cause the smart luggage system to:
determine that the luggage bag is being tampered with based on one or more output signals from the one or more inertial measurement units;
issue an alarm with the at least one of one or more speakers and one or more alarm indicator lights in response to determining that the luggage bag is being tampered with; and
transmit the location of the luggage bag.

12. The smart luggage system of claim 11, further comprising one or more wheel lock actuators coupled to the one or more wheels and communicatively coupled to the one or more processors, wherein, when executed by the one or more processors, the machine readable instructions stored in the one or more memory modules cause the smart luggage system to actuate the one or more wheel lock actuators to prevent the one or more wheels from rotating in response to determining that the luggage bag is being tampered with.

13. The smart luggage system of claim 1, further comprising:
one or more cameras communicatively coupled to the one or more processors; and
at least one of one or more speakers and one or more alarm indicator lights,
wherein, when executed by the one or more processors, the machine readable instructions stored in the one or more memory modules cause the smart luggage system to:
determine that the luggage bag is being tampered with based on image data received from the one or more cameras; and
issue an alarm with the at least one of one or more speakers and one or more alarm indicator lights in response to determining that the luggage bag is being tampered with.

14. The smart luggage system of claim 1, wherein the luggage bag further comprises one or more footrests, wherein the one or more footrests are configured to be deployed from an undeployed stored configuration into a deployed configuration in which a user may stand on the footrests and move along with and be transported by the luggage bag.

15. The smart luggage system of claim 1, further comprising a compartment addition comprising a plurality of protrusions, wherein the luggage bag comprises a plurality of slots configured to receive the plurality of protrusions when the compartment addition is coupled to the luggage bag.

16. A smart luggage system comprising:
a luggage bag comprising one or more wheels and one or more footrests, wherein the one or more footrests are configured to be deployed from an undeployed stored configuration into a deployed configuration in which a user may stand on the footrests;
one or more processors;
one or more memory modules communicatively coupled to the one or more processors;
one or more wheel actuators coupled to the one or more wheels and communicatively coupled to the one or more processors; and
machine readable instructions stored in the one or more memory modules that cause the smart luggage system to perform at least the following when executed by the one or more processors:
actuate the one or more wheel actuators to move the luggage with the footrests in the deployed configuration.

17. The smart luggage system of claim 16, further comprising a compartment addition comprising a plurality of protrusions, wherein the luggage bag comprises a plurality of slots configured to receive the plurality of protrusions when the compartment addition is coupled to the luggage bag.

18. The smart luggage system of claim 16, further comprising at least one handlebar that the user can hold onto, the at least one handlebar including tactile input hardware that the user may manipulate while standing on the footrests in order to brake and accelerate the smart luggage system.

19. The smart luggage system of claim 18, further comprising one or more handle positions sensors configured to output a signal indicative of a position of the at least one retractable handle, wherein, when executed by the one or more processors, the machine readable instructions stored in the one or more memory modules cause the smart luggage system to control the one or more wheel actuators in response to the position of the at least one retractable handle.

20. The smart luggage system of claim 16, further comprising one or more inertial measurement units to assist with tracking, orientation, and stability.
